(19) United States
(12) Patent Application Publication
(10) Pub. No.: US 2015/0167359 A1
(43) Pub. Date: Jun. 18, 2015

(54) HOOD STOP ASSEMBLIES FOR A VEHICLE AND METHODS FOR SETTING A POSITION OF A VEHICLE HOOD

(71) Applicant: FORD GLOBAL TECHNOLOGIES, INC., Dearborn, MI (US)

(72) Inventor: RODOLFO REYES LUNA, Toluca (MX)

(73) Assignee: FORD GLOBAL TECHNOLOGIES, INC., Dearborn, MI (US)

(21) Appl. No.: 14/106,296

(22) Filed: Dec. 13, 2013

(51) Int. Cl. E05B 83/24

(52) U.S. Cl. CPC E05B 83/24

(57) ABSTRACT

Hood stop assemblies and methods of setting a hood of a vehicle to a support frame. The receptacle includes an interior wall that defines a first part of a linear ratchet. The shaft includes a head and a wedge tooth lock that forms a second part of the linear ratchet. The first part of the linear ratchet engages the second part of the linear ratchet in a range of height positions. The methods disclosed relate to setting, adjusting and locking the hood stop.

### TECHNICAL FIELD

This disclosure relates to a hood stop assembly for setting the flushness of a hood of a vehicle relative to the surrounding vehicle body structure.

### BACKGROUND

Referring to FIG. 1, a vehicle 20 is shown with a hood 22 assembled over the engine compartment of the vehicle 20 on a supporting frame. The position of the hood 22 is checked and adjusted to achieve the ideal flushness of the hood 22 relative to the fenders 24 and other surrounding outer body panels. A hood stop 26 permits adjustment of the height of the hood. The hood stop 26 may have a rubber top 28 and a threaded shaft 30. The threaded shaft 30 is assembled to the supporting frame structure of the vehicle 20. The hood stop 26 is rotated to set the hood 22 at a predetermined height. After the hood stop is adjusted, the hood 22 is closed and the height and the height of hood 22 are checked relative to the surrounding outer body panels.

If the hood height is not flush with the surrounding outer body panels, the hood is opened and the height of the hood stop 26 must be readjusted. This process is repeated until the height of the hood 22 is acceptable. In vehicle assembly operations, this procedure for adjusting the height of the hood 22 increases labor costs and assembly time.

The height of the hood stop 26 can be improperly adjusted during a service operation. The height of the hood 22 may need to be readjusted after a front end collision repair.

The above problems and other problems are addressed by this disclosure as summarized below.

### SUMMARY

The present disclosure relates to a hood stop assembly for setting a selected height position of a hood of a vehicle relative to a support frame for the hood. The hood stop assembly includes a receptacle attached to the support frame. The receptacle defines an opening, and a plurality of teeth is axially arranged within the opening. The hood stop assembly also includes a stop that has a shaft partially received in the opening and a head at an upper end of the shaft and disposed above the receptacle. The stop has a locking member selectively connecting the stop to the receptacle to fix the shaft to the receptacle with the hood engaging the head at the selected height position. The locking member also has at least one wedge lock tooth that is received in at least one of the plurality of teeth. The hood stop assembly further includes a release operatively connected to the locking member that is actuated to disengage the wedge lock tooth from the plurality of teeth.

The hood stop assembly may include a locking member having a locking projection and the receptacle may further define a slot. The stop is rotatable to engage and disengage the locking projection from the slot. The hood stop assembly may further have a second locking member connected to the stop. The second locking member has a second wedge lock tooth. The receptacle includes a second set of teeth for receiving the second wedge lock tooth. The hood stop assembly may include a biasing device positioned between the stop and the receptacle. The biasing device biases the stop upwardly within the receptacle.

The present disclosure also relates to a hood stop assembly that includes a receptacle attached to the support frame and that defines an opening having a first part of a linear ratchet. The hood stop assembly also includes a stop that has a head on an upper end. The stop is inserted into the opening defined by the receptacle with the head extending above the receptacle to engage the hood in a closed position. The stop includes a second part of the linear ratchet that cooperates with the first part of the linear ratchet. The hood stop assembly also has a spring that biases the stop toward the hood in the closed position. When the hood is moved to a closed position, the stop is pressed into the receptacle. The first part of the linear ratchet and the second part of the linear ratchet are relatively movable to insert the stop further into the receptacle and to resist the withdrawal of the stop from the receptacle. The hood stop assembly further includes a release mechanism operable to release the first part of the linear ratchet from the second part of the linear ratchet to selectively allow the stop to be withdrawn from the receptacle.

The hood stop assembly may have a plurality of teeth that is provided within the opening. The stop may include a wedge lock tooth that engages to one of the plurality of teeth when the stop is pressed into the receptacle. The stop may have a locking projection, and a slot may be provided within the opening. When the stop is rotated, the locking projection is inserted into the slot to prevent the stop from moving vertically.

The present disclosure further relates to a hood stop assembly for a vehicle that includes a head for supporting a hood of the vehicle and a shaft connected to the head. The shaft has a locking projection. The hood stop assembly also has a branch connected to the shaft. The branch includes a plurality of wedge lock teeth. The hood stop assembly further includes a receptacle with the shaft and the branch being moveable within the receptacle. The receptacle has an interior wall that having a linear ratchet for engaging with one of the plurality of the wedge lock teeth. The interior wall includes a slot that is engaged by the locking projection. A spring positioned within the receptacle biases the shaft. When the hood of the vehicle is placed on the head, the shaft presses against the spring and one of the plurality of the wedge lock teeth engages the linear ratchet to set a hood stop position. The hood stop position is lockable by rotating the shaft within the receptacle allowing the locking projection to engage the slot. The hood stop assembly may include a branch that is moveable relative to the shaft to disengage one of the plurality of the wedge lock teeth from the linear ratchet.

The present disclosure relates to a method of setting a hood of a vehicle to a support frame. The method includes the step of connecting a receptacle to the support frame. The receptacle includes an interior wall that defines a first part of a linear ratchet. The method includes the step of inserting a shaft into the receptacle. The shaft includes a head and a wedge tooth lock. The wedge lock tooth forms a second part of the linear ratchet. The method further includes the step of engaging the first part and the second part of the linear ratchet. The shaft may have a locking projection, and the interior wall of the receptacle defines a slot.

The method may include the step of rotating the shaft to insert the locking projection into the slot to further set the hood. The method may include the step of operating a release mechanism to disengage the first part and the second part of the linear ratchet. The method may also include the step of rotating the shaft to release the locking projection from the slot and the step of operating a release mechanism to disengage the first part and the second part of the linear ratchet. The method may also include rotating the shaft to release the locking projection from slot.

The above aspects of this disclosure and other aspects are described below in greater detail with reference to the attached drawings.

### BRIEF DESCRIPTION OF THE DRAWINGS

FIG. 1 is a fragmentary view of a vehicle with a prior art hood stop.

FIG. 2 is a top plan view of a hood stop assembly of the present disclosure.

FIG. 3 is a cross-section view of the hood stop assembly taken along the line 3-3 in FIG. 2.

FIG. 4 is a schematic view showing the hood stop assembly with the hood initially engaging the hood stop assembly.

FIG. 5 is a schematic view showing the hood stop assembly with the hood engaging the hood stop assembly with the hood closed.

FIG. 6 is a side elevational view of another embodiment of the hood stop assembly in an extended position.

FIG. 7 is a cross-section view of the hood stop assembly of FIG. 6 taken along the line 7-7 in FIG. 6.

FIG. 8 is a front elevational view of the hood stop assembly of FIG. 6 in a set or contracted position.

FIG. 9 is a cross-section view of the receptacle of the hood stop assembly of FIG. 6 taken along the line 9-9 in FIG. 8.

FIG. 10 is a side elevational view of the hood stop assembly of FIG. 6 in a partially locked position.

FIG. 11 is a cross-section view of the hood stop assembly of FIG. 6 taken along the line 11-11 in FIG. 10.

FIG. 12 is a side elevational view of the hood stop assembly of FIG. 6 in a fully locked position.

FIG. 13 is a cross-section view of the hood stop assembly of FIG. 6 taken along the line 13-13 in FIG. 12.

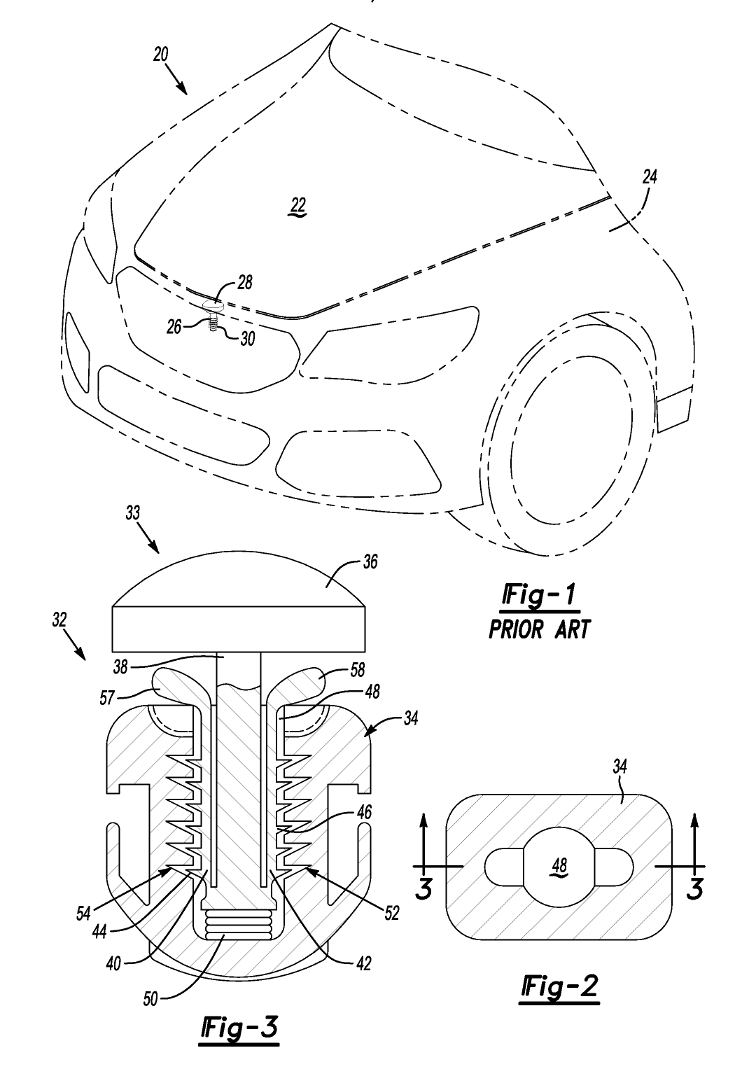

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

Referring to FIGS. 2 and 3, a hood stop assembly 32 made according to the embodiment of this disclosure includes a stop 33 and a receptacle 34. The stop 33 has a head 36 contacts and supports the hood of the vehicle. A rubber or a material having a soft surface is provided on the head 36. The stop 33 also includes a shaft 38 partially received in the receptacle 34. A pair of opposing locking members 40 and 42 is attached to the shaft 38. In certain embodiments, only one locking member may be provided. Each locking member 40 or 42 includes at least one wedge lock tooth 44 or 46. A series of axially arranged wedge lock teeth are provided along the edge of the locking member 40, locking member 42, or both to form a part of a linear ratchet. Each locking member 40 or 42 includes a release 57 and 58, respectively. The locking members 40 and 42 are spaced from the shaft 38, except at the bottom of the shaft 38 where the locking members 40 and 42 are attached to the shaft 38.

The receptacle 34 defines an opening 48 that receives the shaft 38 and the locking members 40 and 42. The opening 48 includes an inner wall that defines a first set of teeth 52 and a second set of teeth 54. The first and second sets of teeth are axially aligned on opposite sides of the shaft 38 from each other. In an alternative embodiment, only one set of teeth may be provided. Each set of teeth forms a part of a linear ratchet. A biasing device 50, such as a spring, is positioned in between the shaft 38 and the base of the opening 48 of the receptacle 34. The biasing device 50 biases the shaft 38 out of the receptacle 34.

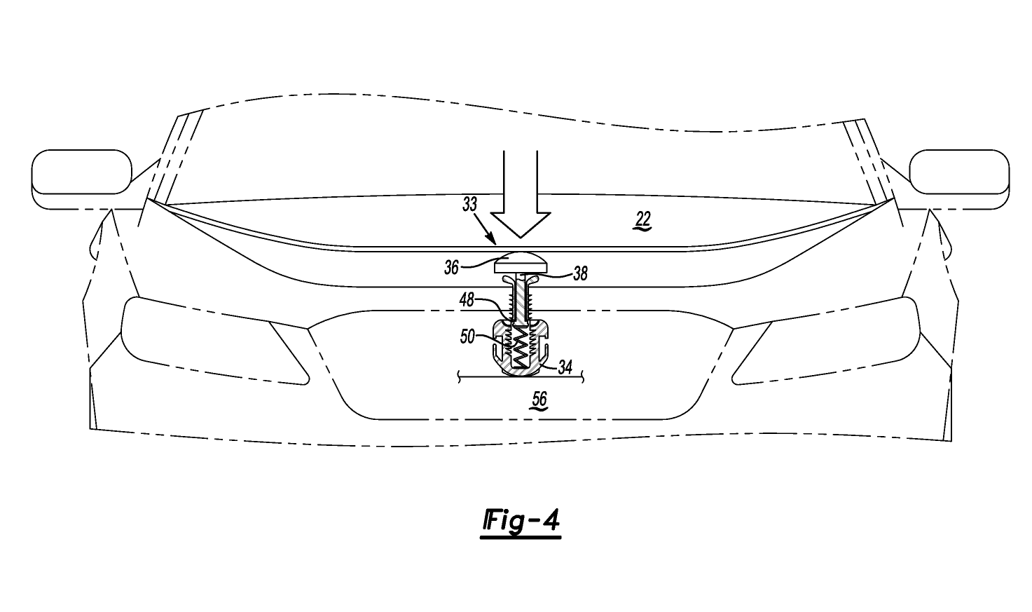

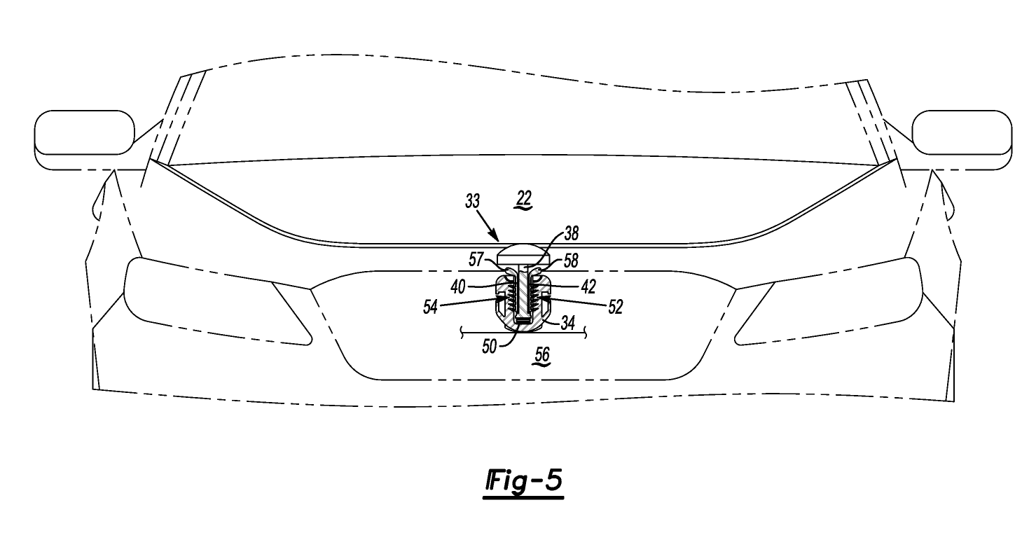

Referring to FIG. 4, the receptacle 34 is mounted to a support frame 56 of the vehicle, to a fender, or other adjacent structure of the vehicle 20. The shaft 38 is received in the opening 48 of the receptacle 34 and extends outwardly from the receptacle 34. The hood 22 of the vehicle 20 is placed on top of the head 36 of the stop 33. Referring to FIG. 5, the weight of the hood 22 presses the shaft 38 towards the bottom of the receptacle 34. The locking members 40 and 42 and their corresponding plurality of teeth 52 and 54 cooperate as two parts of a linear ratchet. The wedge lock teeth of the locking members 40 and 42 are received by the respective set of teeth 52 or 54 when the shaft 38 is pressed down. The wedge lock tooth is received in a tooth of the receptacle preventing the shaft 38 from moving up because the biasing device 50 presses the wedge lock tooth against the corresponding tooth of the receptacle 34. The shaft 38 may move down if there is space left for the shaft 38 to travel down to the bottom of the receptacle 34.

The height position of the hood 22 relative to the support frame 56 can be adjusted even if the stop 33 is locked by operating the release mechanism. The release 57 and 58 can be pressed towards the shaft 38 to release the wedge lock teeth of the locking members 40 and 42 from the sets teeth of the receptacle 52 and 54. The biasing device 50 pushes against the shaft 38 to extend the shaft 38 away from the receptacle 34. The release mechanism selectively withdraws the stop 33 from the receptacle 34. The steps described above can be repeated until the desired height position of the hood 22 is achieved relative to the support frame 56. The hood stop assembly 32 provides a mechanism for easily and precisely setting and adjusting the height of the hood relative to the support frame of the hood. The hood stop assembly 32 is self-adjusting and provides several height increments for the head with a release mechanism for resetting the height of the hood.

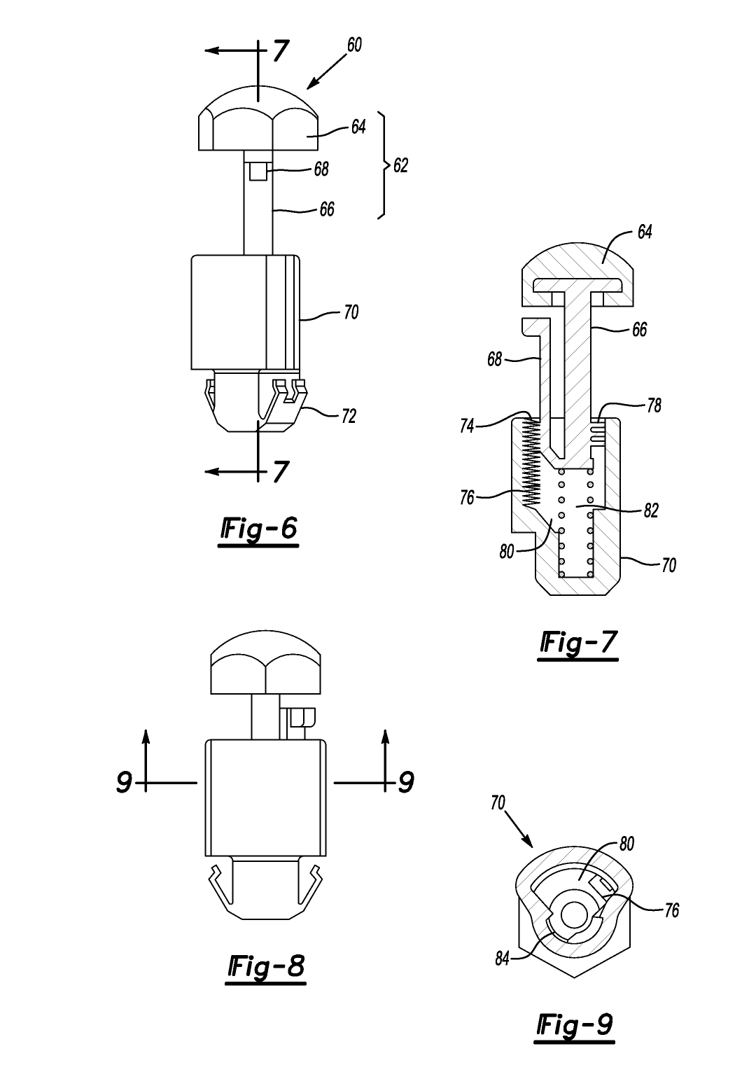

Referring to FIG. 6, another embodiment of a hood stop assembly 60 is illustrated that includes a secondary locking mechanism. The secondary locking mechanism of the hood stop assembly 60 further improves the preciseness and the convenience provided by the self-adjusting feature of the hood stop assembly 60.

The hood stop assembly 60 includes a stop 62 having a head 64 that supports the hood 22. A shaft 66 is attached to the head 64, and a locking branch 68 is provided for setting a selected height position of the hood 22. The hood stop assembly 60 further includes a receptacle 70 that partially receives the shaft 66. A clip 72 is provided below the receptacle 70 to secure the hood stop assembly to a supporting frame, fender, or other adjacent structure of the vehicle.

Referring to FIG. 7, the lock branch 68 is spaced from the shaft and is connected to the bottom of the shaft 66. A plurality of wedge lock teeth 74 are axially arranged on the lower portion of the lock branch 68. The receptacle 70 defines an opening 80. The opening 80 is asymmetrical to accommodate the lock branch 68 that is attached to only one side of the shaft. The interior wall of the receptacle 70 that aligns with the lock branch 68 defines a plurality of teeth 76 that are adapted to receive the wedge lock teeth 74 of the lock branch 68. The wedge lock teeth 74 of the lock branch 68 are one part of a linear ratchet, and the plurality of teeth 76 of the lock branch 68 serve as the other part of the linear ratchet. A biasing device 82, such as a spring, is also provided between the bottom of the shaft 66 and the receptacle 70. One end of the biasing device 82 is attached to the shaft 66 and the other end of the biasing device 82 is attached to the bottom of the receptacle 70.

The secondary locking mechanism of the hood stop assembly 60 includes a plurality of locking projections 78. The locking projections 78 are axially arranged and attached to the side of the shaft 66 that is opposite the lock branch 68. Referring to FIGS. 8 and 9, the secondary locking mechanism further includes a plurality of slots 84 defined on the interior wall of the receptacle 70 and within the opening 80 for receiving the locking projections 78. The opening 80 is asymmetrical allowing the shaft 66 to be rotated within the opening 80. Rotating the shaft within the opening engages and disengages the plurality of locking projections 78 of the lock branch 68 and the plurality of slots 84 of the receptacle 70.

The hood stop assembly 60 is mounted to a support frame, fender, or adjacent support structure of a vehicle 20. The shaft 66 extends away from the receptacle 70 and is partially received within the receptacle 70. Some of the wedge lock teeth 74 of the lock branch 68 interlock with some of the teeth of the receptacle 70. The biasing device 82 biases the shaft 66 to extend away from the receptacle 70 preventing the shaft 66 from being moved upwards. Without operating the release mechanism, the shaft 66 can only be moved further into the receptacle. The shaft 66 is oriented with the locking projections 78 disengaged with the slots 84 of the receptacle.

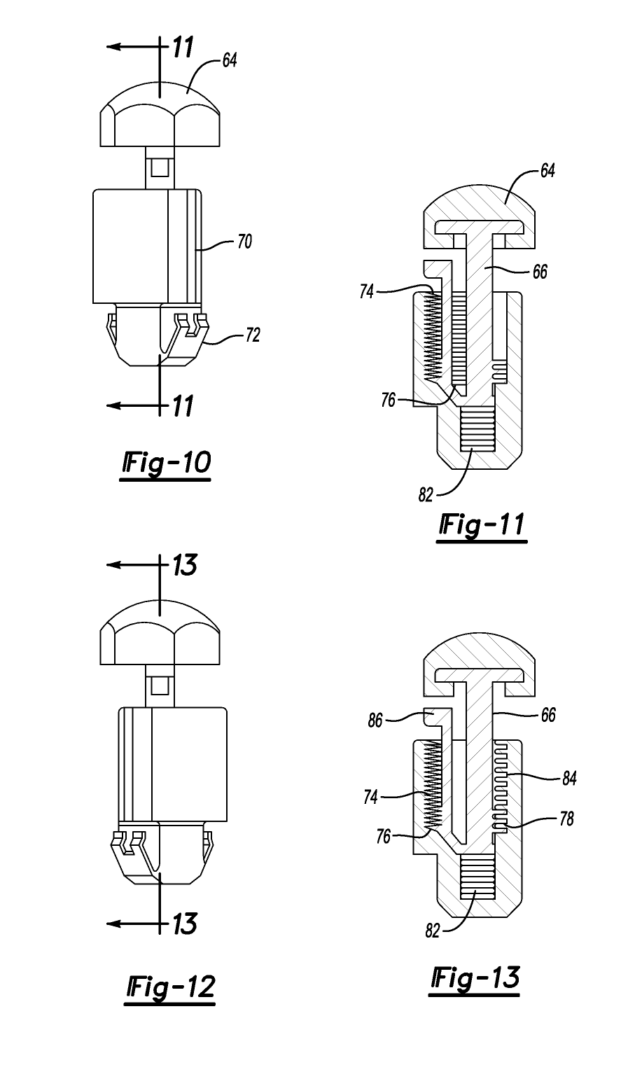

Referring to FIGS. 10 and 11, when the hood 22 is in a closed position, the hood is placed on the head 64 and presses the shaft 66 towards the bottom of the receptacle 70. Depending on the weight of the hood 22, additional wedge lock teeth 74 interlock with the teeth 76 to accommodate the added weight until there is no more space for the shaft to travel towards the bottom of the receptacle 70. In FIG. 11, the width of the teeth 76 on the interior wall of the receptacle 70 is sufficient to maintain the interlocking position of the wedge lock teeth 74 when the shaft 66 is rotated.

Referring to FIGS. 12 and 13, once the desired height position of the hood relative to the support frame is achieved, the shaft 66 can be rotated to engage the secondary locking mechanism. The secondary locking mechanism is engaged when the locking projections 78 are inserted into the plurality of slots 84. The hood stop assembly 60 provides a way to easily, precisely, and flexibly adjust and set the hood position. The linear ratchet allows the hood to be adjusted in height in a range of increments. The linear ratchet and the secondary locking mechanism rigidly set the hood position. The height of the hood relative to the support frame can be reset by opening the hood and rotating the shaft 66 to disengage the locking projections 78 from the slots 84. The lock branch 68 includes a release 86 that can be pressed against the shaft 66. The wedge lock teeth 74 disengage the teeth 76 by pressing the release 86 against the shaft 66. The biasing device 82 pushes the shaft 66 to extend the shaft away from the receptacle 70 moving the shaft toward the starting position, as shown in FIG. 7.

While exemplary embodiments are described above, it is not intended that these embodiments describe all possible forms of the disclosed apparatus and method. Rather, the words used in the specification are words of description rather than limitation, and it is understood that various changes may be made without departing from the spirit and scope of the disclosure as claimed. The features of various implementing embodiments may be combined to form further embodiments of the disclosed concepts.

What is claimed is:

1. A hood stop assembly comprising:
a receptacle defining an opening including a plurality of teeth axially arranged within the opening;
a stop including:
a shaft received in the opening;
a locking member having a wedge lock tooth that is received in one of the plurality of teeth; and
a release operatively connected to the locking member that is actuated to disengage the wedge lock tooth from the plurality of teeth.

2. The hood stop assembly of claim 1, further comprising a second locking member connected to the stop, the second locking member having a second wedge lock tooth, the receptacle further including a second set of teeth for receiving the second wedge lock tooth.

3. The hood stop assembly of claim 1, further comprising a biasing device positioned in between the stop and the receptacle, wherein the biasing device biases the stop to be raised from the receptacle.

4. The hood stop assembly of claim 1, wherein the locking member is spaced from the stop to allow the locking member to move relative to the stop, wherein when the locking member is moved towards the stop, the wedge lock tooth of the locking member disengages from the teeth of the receptacle.

5. The hood stop assembly of claim 1, wherein the locking member includes a locking projection and the receptacle defines a slot, the stop being rotatable to engage and disengage the locking projection from the slot.

6. The hood stop assembly of claim 1, wherein the plurality of teeth of the receptacle forms a linear ratchet.

7. A hood stop assembly for setting a selected height position of a hood relative to a support frame for the hood of a vehicle, the hood stop assembly comprising:
a receptacle attached to the support frame, the receptacle defining an opening, wherein a first part of a linear ratchet is provided within the opening;
a stop including a head on an upper end, wherein the stop is inserted into the opening defined by the receptacle with the head extending above the receptacle to engage the hood in a closed position, wherein the stop includes a second part of the linear ratchet that cooperates with the first part of the linear ratchet;
a spring biasing the stop toward the hood in the closed position, wherein the stop is pressed into the receptacle by moving the hood to the closed position with the first part of the linear ratchet and the second part of the linear ratchet being relatively movable to insert the stop further into the receptacle and resisting withdrawal of the stop from the receptacle; and
a release mechanism operative to release the first part of the linear ratchet from the second part of the linear ratchet to selectively withdraw the stop from the receptacle.

8. The hood stop assembly of claim 7, wherein a plurality of teeth is provided within the opening, the stop including a wedge lock tooth that engages to one of the plurality of teeth when the stop is pressed into the receptacle.

9. The hood stop assembly of claim 7, wherein the stop includes a locking projection and a slot is provided within the opening, when the stop is rotated, the locking projection inserts into the slot to prevent the stop from moving vertically.

10. A hood stop assembly for a vehicle comprising:
a head for supporting a hood of the vehicle;
a shaft connected to the head, the shaft including a locking projection;
a branch connected to the shaft, the branch including a plurality of wedge lock teeth;
a receptacle, the shaft and the branch being moveable within the receptacle, the receptacle including an interior wall that has a linear ratchet for engaging with one of the plurality of the wedge lock teeth, the interior wall further including a slot for engaging with the locking projection; and
a spring positioned within the receptacle for biasing the shaft, wherein when the hood of the vehicle is laid onto the head, the shaft presses against the spring and one of the plurality of the wedge lock teeth engage with the linear ratchet to set a hood stop position, the hood stop position being lockable by rotating the shaft within the receptacle to allow the locking projection to engage with the slot.

11. The hood stop assembly of claim 10, the branch being moveable relative to the shaft to disengage one of the plurality of the wedge lock teeth from the linear ratchet.

12. A method of setting a hood of a vehicle to a support frame comprising:
connecting a receptacle to the support frame, the receptacle including an interior wall that defines a first part of a linear ratchet;
inserting a shaft into the receptacle, the shaft including a head and a wedge tooth lock that forms a second part of the linear ratchet; and
engaging the first part and the second part of the linear ratchet.

13. The method of claim 12, wherein the shaft includes a locking projection and the interior wall of the receptacle defines a slot, the method further comprising rotating the shaft to insert the locking projection into the slot to further set the hood.

14. The method of claim 12, further comprising operating a release mechanism to disengage the first part and the second part of the linear ratchet.

15. The method of claim 12, further comprising rotating the shaft to release the locking projection from slot.
